(19) United States
(12) Patent Application Publication
(10) Pub. No.: US 2008/0216627 A1
(43) Pub. Date: Sep. 11, 2008

(54) Miter saw assembly with offset support assembly

(75) Inventors: Brian Taylor, Chicago, IL (US); John Janson, Chicago, IL (US); Daniel Andreas Schadegg, Wheeling, IL (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignees: Credo Technology Corporation, Broadview, IL (US); Robert Bosch GmbH, Stuttgart (DE)

(21) Appl. No.: 11/714,001

(22) Filed: Mar. 5, 2007

(51) Int. Cl. B26D 7/02

(52) U.S. Cl. 83/468.3

(57) ABSTRACT

A miter saw assembly includes a base and a turntable rotatable in relation to the base. The miter saw further includes a cutting assembly having a saw blade configured to cut a work piece positioned on the turntable. In addition, the miter saw includes a dust conduit positioned to receive saw dust generated by a cutting operation of the cutting assembly on the work piece. The miter saw also includes a support assembly coupled to the turntable and configured to support the cutting assembly, the support assembly including (i) a carriage mechanism configured to enable linear movement of the cutting assembly in relation to the turntable, and (ii) a pivot mechanism configured to enable pivotal movement of the cutting assembly in relation to the turntable. The saw blade possesses (i) a first lateral face that defines a first plane, and (ii) a second lateral face that defines a second plane. A zone is defined between the first plane and the second plane. At least a portion of the dust conduit is positioned in the zone. All of the pivot mechanism is spaced apart from the zone.

### FIELD OF THE DISCLOSURE

The present disclosure relates to a power saw such as a power miter saw.

### BACKGROUND OF THE DISCLOSURE

Power miter saws are typically used for sawing material, for example, construction lumber. The miter saws include a base or platform on which a turntable is positioned. The turntable is used to support a work piece thereon. A support assembly of the miter saw is connected to the turntable and functions to support a cutting assembly that is operable to perform a cutting operation on the work piece. The support assembly typically includes functionality to enable the cutting assembly to pivot in relation to the turntable. The support assembly further may include functionality to enable the cutting assembly to move linearly over the turntable. An example of such a miter saw is disclosed in U.S. Pat. No. 6,769,338 issued to Svetlik et al.

Sawdust is generated as a byproduct during a cutting operation of a miter saw. In order to address this fact, miter saws typically include a dust collection system that receives the byproduct dust at the rear side of a rotating saw blade of the cutting assembly of the miter saw. The dust collection system typically includes a dust conduit positioned on the rear side of the saw assembly. The dust conduit includes an entrance port configured to receive a flow of dust being generated by interaction between the saw blade and the work piece. The dust conduit is configured to guide the flow of dust to an exit port thereof. A dust collection bag may be attached to the exit port to receive and collect the dust. Alternatively, a vacuum hose of a vacuum system may be attached to the exit port to receive and guide the dust to a receptacle of the vacuum system.

It is a goal of miter saw designers to construct a miter saw as compact as possible. To this end, designers of miter saws attempt to make the depth of the miter saw, measured front to back, as small as possible. This provides for ease of transport and storage, and reduces space utilized at a work site. Thus, in most designs, the support assembly of the miter saw is positioned immediately behind the saw blade of the miter saw. However, placement of the support assembly immediately behind the saw blade compromises dust collection capabilities of the miter saw. In particular, by placing the support assembly immediately behind the saw blade, the dust conduit must be placed above or to the side of the saw blade or at another location that is out of the normal (or theoretical) flow of dust being ejected by the cutting assembly.

Some miter saw designers have chosen to interpose a dust conduit between the support assembly and the saw blade. However, while this arrangement may improve the dust collection capabilities of the miter saw, it results in a miter saw with a larger footprint.

What is needed therefore is a miter saw having optimal dust collection capabilities that also possesses a compact arrangement of components.

### SUMMARY OF THE DISCLOSURE

In accordance with one embodiment, there is provided a miter saw assembly that includes a base and a turntable rotatable in relation to the base. The miter saw further includes a cutting assembly having a saw blade configured to cut a work piece positioned on the turntable. In addition, the miter saw includes a dust conduit positioned to receive saw dust generated by a cutting operation of the cutting assembly on the work piece. The miter saw also includes a support assembly coupled to the turntable and configured to support the cutting assembly, the support assembly including (i) a carriage mechanism configured to enable linear movement of the cutting assembly in relation to the turntable, and (ii) a pivot mechanism configured to enable pivotal movement of the cutting assembly in relation to the turntable. The saw blade possesses (i) a first lateral face that defines a first plane, and (ii) a second lateral face that defines a second plane. A zone is defined between the first plane and the second plane. At least a portion of the dust conduit is positioned in the zone. All of the pivot mechanism is spaced apart from the zone.

According to another embodiment, there is provided a miter saw assembly that includes a base and a turntable rotatable in relation to the base. The miter saw further includes a cutting assembly having a saw blade configured to cut a work piece positioned on the turntable. The miter saw also includes a dust conduit positioned to receive saw dust generated by a cutting operation of the cutting assembly on the work piece. In addition, the miter saw includes a support assembly coupled to the turntable and configured to support the cutting assembly, the support assembly including a pivot mechanism configured to enable pivotal movement of the cutting assembly in relation to the turntable. The saw blade possesses (i) a first lateral face that defines a first plane, and (ii) a second lateral face that defines a second plane. A zone is defined between the first plane and the second plane. At least a portion of the dust conduit is positioned in the zone. All of the pivot mechanism is spaced apart from the zone.

Pursuant to another embodiment, there is provided an assembly that includes a cutting assembly having a saw blade configured to cut a work piece. The assembly further includes a dust conduit positioned to receive saw dust generated by a cutting operation of the cutting assembly on the work piece. The assembly also includes a support assembly coupled to the turntable and configured to support the cutting assembly, the support assembly including (i) a carriage mechanism configured to enable linear movement of the cutting assembly in relation to the turntable, and (ii) a pivot mechanism configured to enable pivotal movement of the cutting assembly in relation to the turntable. The saw blade possesses (i) a first lateral face that defines a first plane, and (ii) a second lateral face that defines a second plane. A zone is defined between the first plane and the second plane. At least a portion of the dust conduit is positioned in the zone. All of the pivot mechanism is spaced apart from the zone.

### BRIEF DESCRIPTION OF THE DRAWINGS

The accompanying drawings illustrate various embodiments of the present disclosure and together with a description serve to explain the principles of the disclosure. In the drawings:

FIG. 1 is a front perspective view of the miter saw assembly of the present disclosure;

FIG. 2 is another front perspective view of the miter saw assembly of FIG. 1 with a work piece positioned on the turntable of the saw assembly;

FIG. 3 is another perspective view of the miter saw assembly of FIG. 1 with the carriage structure of the carriage mechanism of the support assembly moved in its relation to its position shown in FIG. 1;

FIG. 4 is a rear perspective view of the miter saw assembly of FIG. 1;

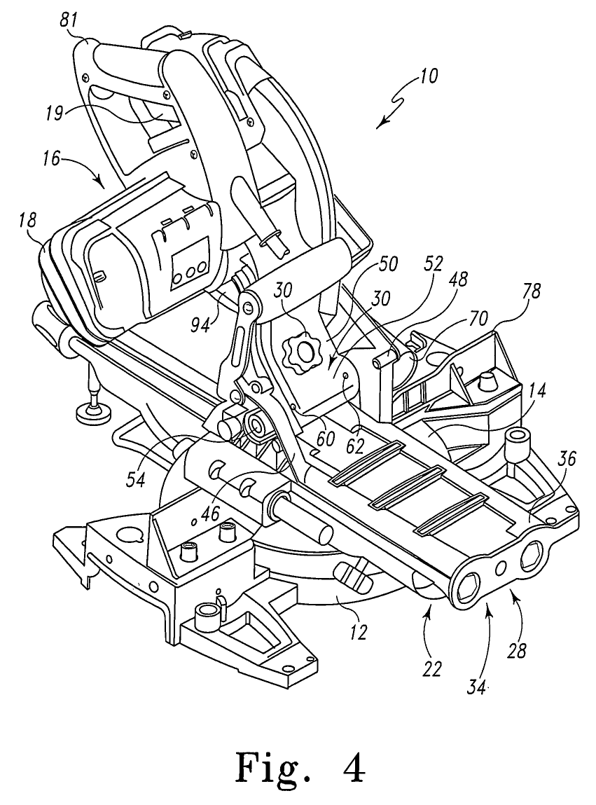

FIG. 5 is a rear elevational view of a portion of the miter saw assembly of FIG. 1, with the zone Z shown defined between the plane P1 and the plane P2;

FIG. 6 is an exploded perspective view of various components of the miter saw assembly of. FIG. 1;

FIG. 7 is a fragmentary perspective view of another portion of the miter saw assembly of FIG. 1;

FIG. 8 is a fragmentary perspective view of yet another portion of the miter saw assembly of FIG. 1; and

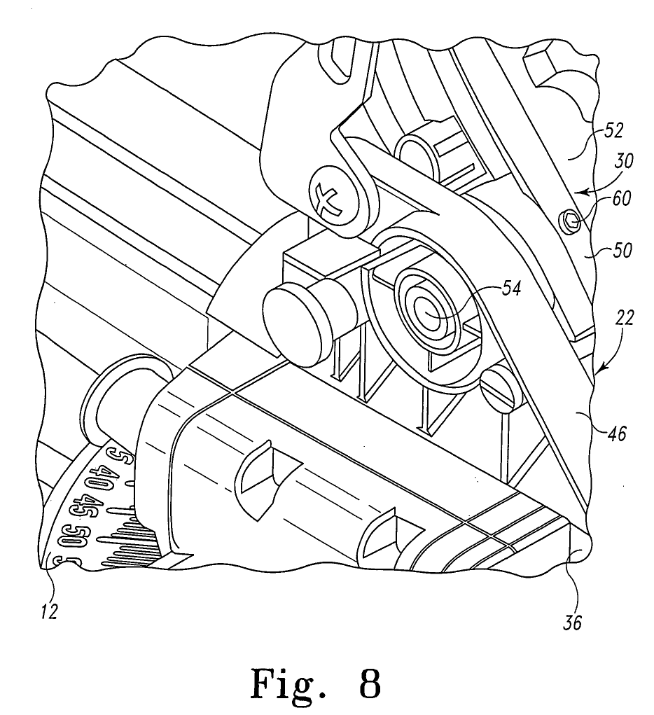

FIG. 9 is a cross sectional view of the circular saw blade of the miter saw assembly of FIG. 1 showing the planes P1, P2 and the zone Z.

Corresponding reference characters indicate corresponding parts throughout the several views. Like reference characters indicate like parts throughout the several views.

### DETAIL DESCRIPTION OF THE DISCLOSURE

While the saw assembly described herein is susceptible to various modifications and alternative forms, specific embodiments thereof have been shown by way of example in the drawings and will herein be described in detail. It should be understood, however, that there is no intent to limit the saw assembly to the particular forms disclosed, but on the contrary, the intention is to cover all modifications, equivalents, and alternatives falling within the spirit and scope of the invention as defined by the appended claims.

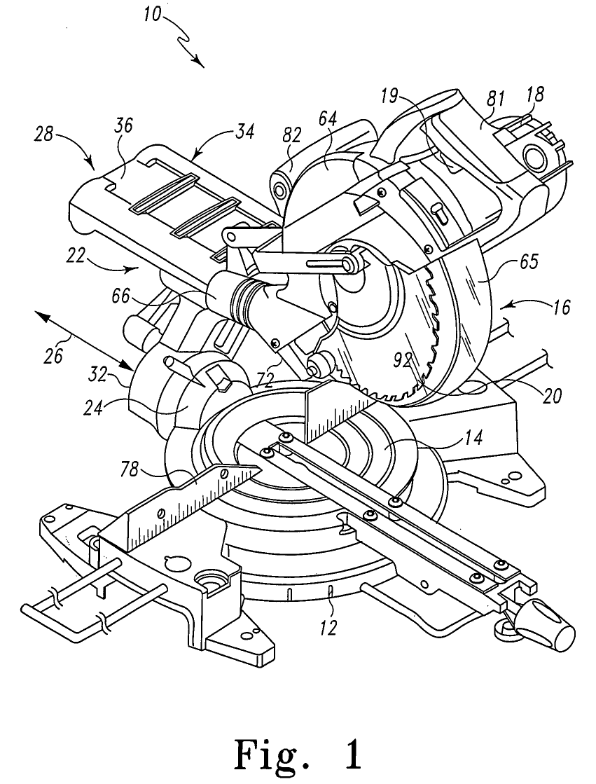

Referring now to FIGS. 1-3, there is shown a miter saw assembly 10. The miter saw assembly 10 includes a base 12 and a turntable 14 that is rotatable on the base 12. The miter saw assembly 10 further includes a cutting assembly 16. The cutting assembly 16 includes a motor 18 that is operable to rotate a circular saw blade 20. The cutting assembly 16 includes a switch 19 operable to selectively actuate and deactuate the motor. In addition, the miter saw assembly 10 includes a support assembly 22 that is attached to the turntable 14 and configured to support the cutting assembly 16 over the turntable 14.

The support assembly 22 is pivotally attached to the turntable 14 by a pivot mechanism 24 that enables the support assembly 22 to pivot with respect to the turntable about an axis 26 during a setup procedure. This arrangement is configured to enable the cutting assembly 16 to pivot from a vertical position (as shown in FIG. 1) to an angle of 45° in the leftward direction prior to a cutting operation as is well known in the art.

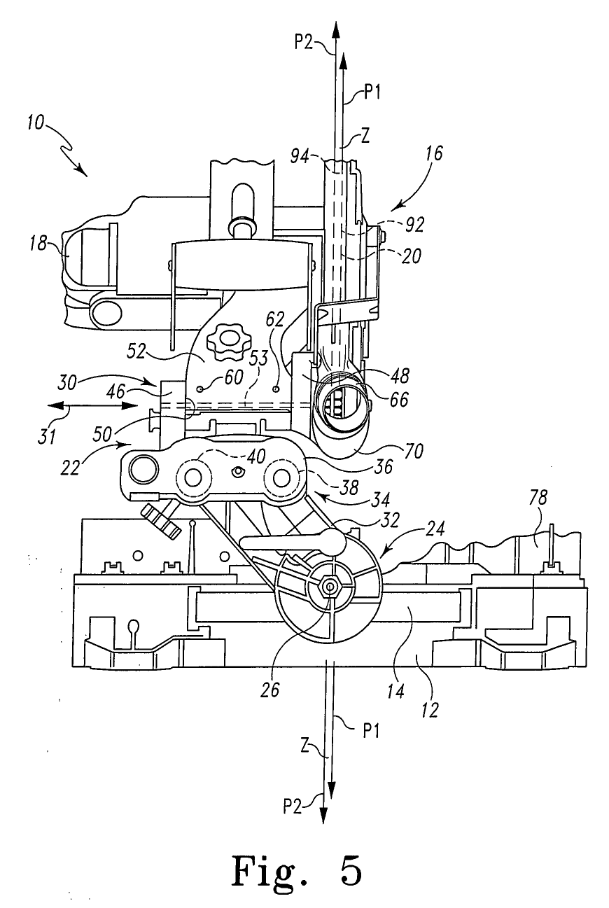

The support assembly includes a carriage mechanism 28 that is configured to enable linear movement of the cutting assembly 16 in relation to the turntable 14 during a cutting operation. The support assembly further includes a pivot mechanism 30 that is configured to enable pivotal movement of the cutting assembly 16 in relation to the turntable 14 during a cutting operation. In particular, the pivot mechanism 30 is configured to enable the cutting assembly 16 to pivot with respect to the turntable 14 about an axis 31 as shown in FIG. 5.

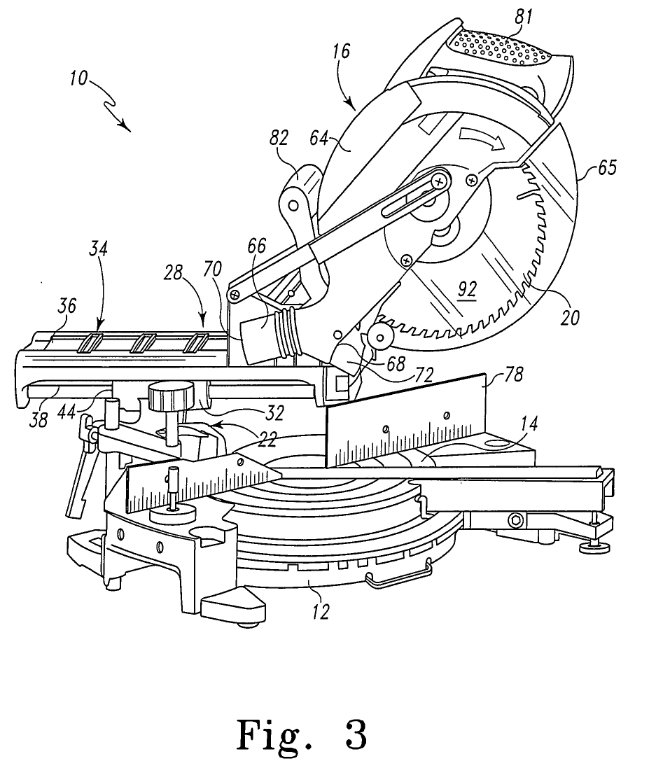

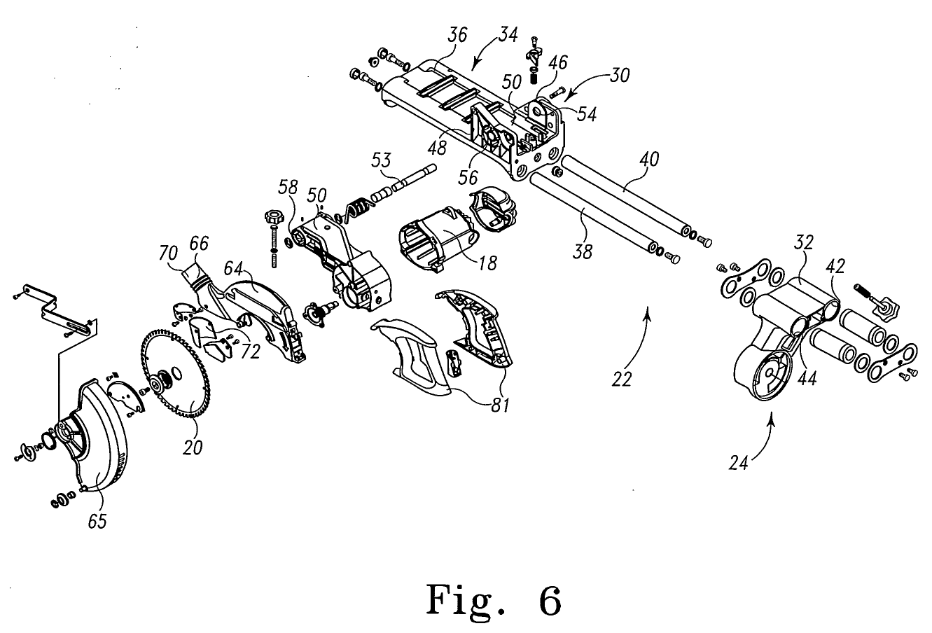

The carriage assembly 28 includes a guide structure 32 that is pivotally connected to the turntable 14 so that the guide structure pivots about the pivot axis 26 (see FIGS. 1 and 5). The carriage assembly 28 also includes a carriage structure 34 that is coupled to the pivot mechanism 30. The carriage structure 34 includes a frame 36 and a pair of rails 38, 40 secured to the frame 36. The guide structure 32 defines a pair of passageways 42, 44 as shown in FIG. 6. The rail 38 of the carriage structure 32 extends through the passageway 44 of the guide structure 32 as shown in FIG. 3. Similarly, the rail 40 of the carriage structure 32 extends through the passageway 42 of the guide structure 32.

The pivot mechanism 30 includes a pair of mounts 46, 48 that are spaced apart from each other to define a mounting space 50 therebetween. The pivot mounts 46, 48 are attached to the frame 36 of the carriage structure 34. The pivot mounts are attached to the frame by being integrally formed therewith during a molding process. The pivot mechanism 30 further includes a support arm 52 that has an end portion which is positioned within the mounting space 50. The mount 46 includes an opening 54 defined therein, while the mount 48 includes an opening 56 defined therein. The end portion of the support arm 50 includes a passageway 58 extending therethrough. The pivot mechanism 30 additionally includes a rod 53 that extends through the opening 54 of the mount 46, the passageway 58 of the support arm 50, and the opening 56 of the mount 48 so as to pivotably couple the support arm 50 to the pair of mounts 46, 48. The rod 53 is preferably made of steel. A pair of set screws 60, 62 secures the rod 53 to the support arm 50 by being tightened against the rod 53.

The miter saw assembly 10 further includes a blade guard 64 and a dust conduit 66 that are connected together by being integrally molded as one piece. It should be appreciated that the blade guard and the dust conduit may alternatively be configured as two separate parts that are attached together or otherwise held in fixed relation to each other. The dust conduit 66 includes an entrance port 68 and an exit port 70. A baffle 72 is connected at the entrance port 68 to assist in guiding the flow of dust into the dust conduit 66. The miter saw assembly 10 further includes a retractable blade guard 65 as shown in FIG. 1.

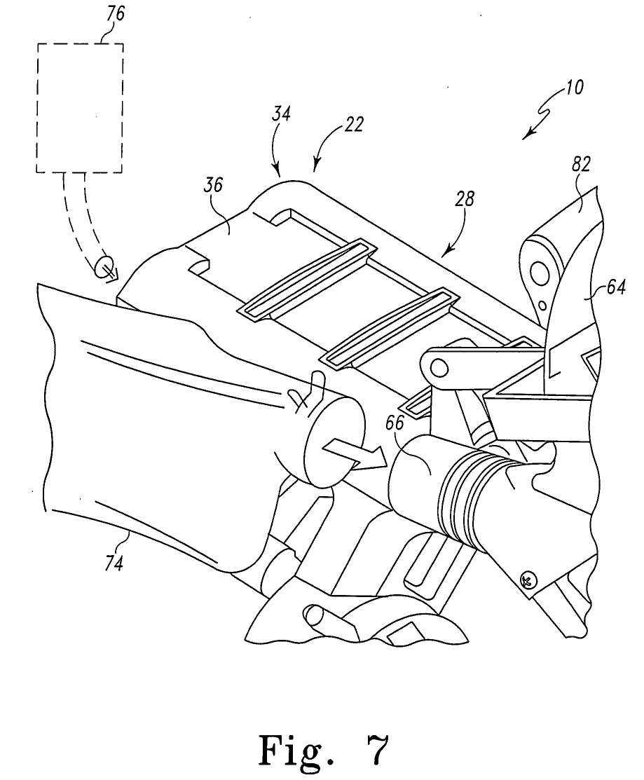

The miter saw assembly 10 further includes a dust collection bag 74 having an inlet that is connected to the exit port 70 of the dust conduit 66. FIG. 7 shows the dust collection bag 74 separated from the exit port 70 for clarity of description. Alternatively, the miter saw assembly 10 includes a vacuum system 76 (shown in phantom in FIG. 7) that includes an input line that is connected in fluid communication with the exit port 70 of the dust conduit 66. FIG. 7 also shows the vacuum system 76 separated from the exit port 70 for clarity of description.

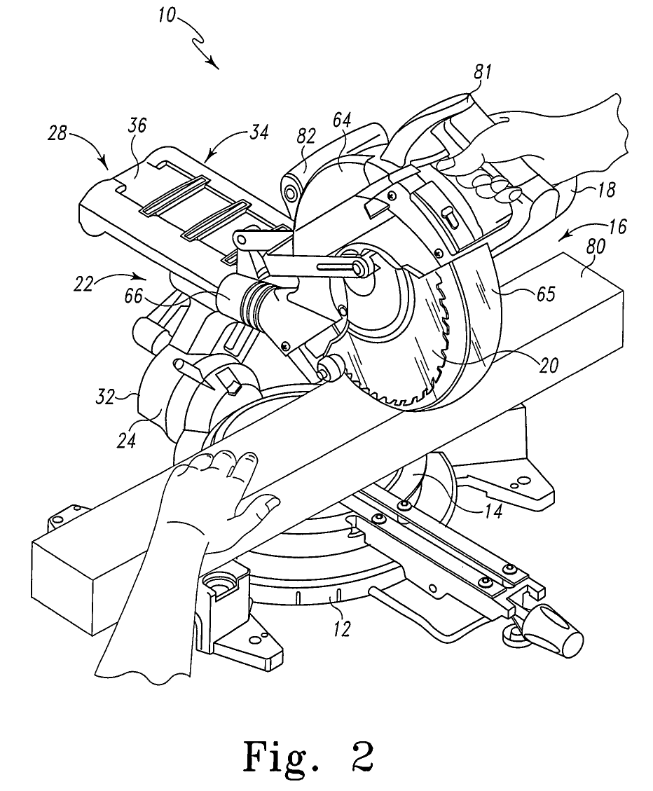

The miter saw assembly 10 also includes a fence 78 (see FIG. 1) positioned over the turntable 14 for aligning a work piece 80 (see FIG. 2) thereon. In addition, the miter saw assembly 10 includes a handle 81 to facilitate movement of the cutting assembly 16 in relation to the turntable 14. The miter saw assembly further includes another handle 82 to facilitate transport of the miter saw assembly 10 from work site to work site.

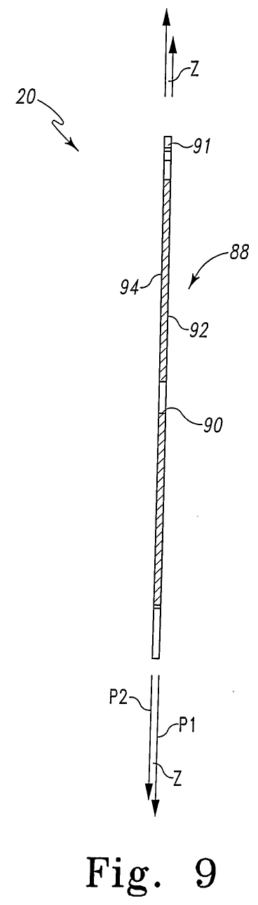

Turning now to FIG. 9, the circular saw blade 20 includes a generally circular plate 88 having a central opening 90 defined therein. A plurality of cutting teeth 91 are attached to periphery of the plate 88 as is well know in the art. The plate 88 of the saw blade 20 possesses a first lateral face 92 that defines a first plane P1 and a second lateral face 94 that defines a second plane P2. A zone Z is defined between the first plane P1 and the second plane P2 as shown in FIGS. 5 and 9. As shown in FIG. 5, all of the pivot mechanism 30 including the rod 53 and the mounts 46, 48 are spaced apart from the zone Z. Further, all of the carriage structure 34 including the frame 36 and the pair of rails 38, 40 are spaced apart from the zone Z. This provides for a compact arrangement of the components of the miter saw assembly 16 (e.g., from front to back), and yet provides an open space in which to position the dust conduit 66 in the normal (or theoretical) flow of dust being ejected by the cutting assembly 16. As further shown in FIG. 5, at least a portion of the dust conduit 66 is positioned within the zone Z. With the inlet of the dust collection bag 74 connected to the exit port 70 of the dust conduit 66, it can be appreciated that at least a portion of the dust collection bag 74 is positioned within the zone Z.

There is a plurality of advantages arising from the various features of each of the embodiments of the saw assembly described herein. It will be noted that alternative embodiments the saw assembly may not include all of the features described yet still benefit from at least some of the advantages of such features. Those of ordinary skill in the art may readily devise their own implementations of the saw assembly that incorporate one or more of the features described herein and fall within the spirit and scope of the present invention as defined by the appended claims.

What is claimed is:

1. A miter saw assembly, comprising:
a base;
a turntable rotatable in relation to said base;
a cutting assembly having a saw blade configured to cut a work piece positioned on said turntable;
a dust conduit positioned to receive saw dust generated by a cutting operation of said cutting assembly on said work piece;
a support assembly coupled to said turntable and configured to support said cutting assembly, said support assembly including (i) a carriage mechanism configured to enable linear movement of said cutting assembly in relation to said turntable, and (ii) a pivot mechanism configured to enable pivotal movement of said cutting assembly in relation to said turntable,
wherein said saw blade possesses (i) a first lateral face that defines a first plane, and (ii) a second lateral face that defines a second plane,
wherein a zone is defined between said first plane and said second plane,
wherein at least a portion of said dust conduit is positioned in said zone, and
wherein all of said pivot mechanism is spaced apart from said zone.

2. The assembly of claim 1, wherein:
said carriage mechanism includes (i) a guide structure coupled to said turntable, and (ii) a carriage structure coupled to said pivot mechanism,
said carriage structure includes at least one rail,
said guide structure defines at least one passageway through which said at least one rail extends, and
all of said at least one rail is spaced apart from said zone.

3. The assembly of claim 1, wherein:
said carriage mechanism includes (i) a guide structure coupled to said turntable, and (ii) a carriage structure coupled to said pivot mechanism,
said carriage structure includes a first rail and a second rail,
said guide structure defines (i) a first passageway through which said first rail extends, and (ii) a second passageway through which said second rail extends,
all of said first rail is spaced apart from said zone, and
all of said second rail is spaced apart from said zone.

4. The assembly of claim 2, wherein:
said carriage structure further includes a frame coupled to said at least one rail, and
said pivot mechanism is coupled to said frame.

5. The assembly of claim 4, wherein:
said pivot mechanism includes (i) a pair of mounts that are spaced apart to define a mounting space, and (ii) an arm located in said mounting space, and
said arm is pivotally connected to said pair of mounts.

6. The assembly of claim 5, wherein:
all of said pair of mounts are spaced apart from said zone.

7. The assembly of claim 5, wherein:
said pivot mechanism further includes a rod that defines a pivot axis,
said rod extends through said pair of mounts and said arm,
said arm pivots about said pivot axis,
all of said rod is spaced apart from said zone.

8. The assembly of claim 1, wherein:
said dust conduit defines an entrance port and an exit port, and
at least a portion of said entrance port is positioned in said zone.

9. The assembly of claim 8, further comprising a dust collection bag connected to said exit port of said dust conduit.

10. The assembly of claim 9, wherein at least a portion of dust collection bag is positioned in said zone.

11. A miter saw assembly, comprising:
a base;
a turntable rotatable in relation to said base;
a cutting assembly having a saw blade configured to cut a work piece positioned on said turntable;
a dust conduit positioned to receive saw dust generated by a cutting operation of said cutting assembly on said work piece;
a support assembly coupled to said turntable and configured to support said cutting assembly, said support assembly including a pivot mechanism configured to enable pivotal movement of said cutting assembly in relation to said turntable,
wherein said saw blade possesses (i) a first lateral face that defines a first plane, and (ii) a second lateral face that defines a second plane,
wherein a zone is defined between said first plane and said second plane,
wherein at least a portion of said dust conduit is positioned in said zone, and
wherein all of said pivot mechanism is spaced apart from said zone.

12. The assembly of claim 11, wherein:
said pivot mechanism includes (i) a pair of mounts that are spaced apart to define a mounting space, and (ii) an arm located in said mounting space, and
said arm is pivotally connected to said pair of mounts

13. The assembly of claim 12, wherein:
all of said pair of mounts are spaced apart from said zone.

14. The assembly of claim 12, wherein:
said pivot mechanism further includes a rod that defines a pivot axis,
said rod extends through said pair of mounts and said arm,
said arm pivots about said pivot axis,
all of said rod is spaced apart from said zone.

15. The assembly of claim 11, wherein:
said dust conduit defines an entrance port and an exit port, and
at least a portion of said entrance port is positioned in said zone.

16. The assembly of claim 15, further comprising a dust collection bag connected to said exit port of said dust conduit.

17. The assembly of claim 16, wherein at least a portion of dust collection bag is positioned in said zone.

18. An assembly, comprising:
a cutting assembly having a saw blade configured to cut a work piece;
a dust conduit positioned to receive saw dust generated by a cutting operation of said cutting assembly on said work piece;
a support assembly coupled to said turntable and configured to support said cutting assembly, said support assembly including (i) a carriage mechanism configured to enable linear movement of said cutting assembly in relation to said turntable, and (ii) a pivot mechanism configured to enable pivotal movement of said cutting assembly in relation to said turntable,
wherein said saw blade possesses (i) a first lateral face that defines a first plane, and (ii) a second lateral face that defines a second plane,
wherein a zone is defined between said first plane and said second plane,
wherein at least a portion of said dust conduit is positioned in said zone, and
wherein all of said pivot mechanism is spaced apart from said zone.

19. The assembly of claim 18, wherein:
said carriage mechanism includes (i) a guide structure coupled to said turntable, and (ii) a carriage structure coupled to said pivot mechanism,
said carriage structure includes at least one rail,
said guide structure defines at least one passageway through which said at least one rail extends, and
all of said at least one rail is spaced apart from said zone.

20. The assembly of claim 19, wherein:
said carriage structure further includes a frame coupled to said at least one rail,
said pivot mechanism includes (i) a pair of mounts that are spaced apart to define a mounting space, said pair of mounts being coupled to said frame, and (ii) an arm located in said mounting space,
said arm is pivotally connected to said pair of mounts, and
all of said pair of mounts are spaced apart from said zone.

21. The assembly of claim 20, wherein:
said pivot mechanism further includes a rod that defines a pivot axis,
said rod extends through said pair of mounts and said arm,
said arm pivots about said pivot axis,
all of said rod is spaced apart from said zone.

22. The assembly of claim 18, wherein:
said dust conduit defines an entrance port and an exit port, and
at least a portion of said entrance port is positioned in said zone.

23. The assembly of claim 22, further comprising a dust collection bag connected to said exit port of said dust conduit, wherein at least a portion of dust collection bag is positioned in said zone.

24. The assembly of claim 22, wherein at least a portion of said exit port is positioned in said zone.
